(19) United States
(12) Patent Application Publication
(10) Pub. No.: US 2009/0251481 A1
(43) Pub. Date: Oct. 8, 2009

(54) CONTRAST RATIO ENHANCEMENT SYSTEM USING LINEARIZED ILLUMINATION CONTROL

(75) Inventors: Mark Francis Rumreich, Indianapolis, IN (US); John Alan Hague, Indianapolis, IN (US)

Correspondence Address: FLETCHER YODER P.C., 7915 FM 1960 RD. WEST, SUITE 330, HOUSTON, TX, 77070, US

(73) Assignee: TTE TECHNOLOGY, INC., Indianapolis, IN (IN)

(21) Appl. No.: 12/097,878

(22) PCT Filed: Dec. 23, 2005
(86) PCT No.: PCT/US05/47215

§ 371 Date: Jun. 17, 2008

(51) Int. Cl. G09G 5/02; G09G 3/36

(52) U.S. Cl. 345/589; 345/102

(57) ABSTRACT

The disclosed embodiments relate to a video unit, comprising an illumination source. The video unit additionally comprises a circuit coupled to the illumination source, the circuit adapted to linearize the illumination source using characteristic parameters of the illumination source.

### FIELD OF THE INVENTION

The present invention relates generally to display systems. More specifically, the present invention relates to a system and method for enhancing contrast ratio in certain display systems.

### BACKGROUND OF THE INVENTION

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art.

Liquid Crystal Displays (LCD) panels are increasingly being used for television display applications mainly due to their light weight and thin profile, as compared to Cathode Ray Tubes (CRTs). However, the performance of LCD panels is still lagging behind CRTs in a number of key areas, one of which is contrast ratio. As an example, the contrast ratio of high-end LCD panels is generally about 500:1, while for a CRT, 10,000:1 is a common ratio.

The contrast ratio may be defined as the ratio of the amount of light of the brightest white to the darkest black of a video frame. Unfortunately, due to their light transmitting properties, pixels of LCD panels transmit enough light, even when in their darkest state, such that a black colored pixel displayed on the LCD panel actually appears to be displayed as a dark gray pixel. Consequently, this significantly lowers the contrast ratio of the LCD panel, which may be more objectionable in low light viewing conditions.

Furthermore, intensity modulation of an illumination source, such as backlight illumination, for improving the contrast ratio of the LCD panels may have an inherent nonlinear output. As one skilled in the art would appreciate, this nonlinear trait of the backlight illumination coupled with a well-known gamma characteristic of the LCD/CRT display may further complicate contrast ratio enhancement thereof.

### SUMMARY OF THE INVENTION

Certain aspects commensurate in scope with the disclosed embodiments are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

The disclosed embodiments relate to a system and method for linearizing an illumination source of a display device, comprising determining a brightness level of a brightest object of a video frame, determining an illumination level for the video frame based on the brightness level of the brightest object, linearizing the illumination level, and providing an illumination of the display device based on the linearized illumination level. In addition to LCDs, the disclosed system and method may further apply to digital light displays (DLPs) and to liquid crystal on silicon (LCOS) display systems.

### BRIEF DESCRIPTION OF THE DRAWINGS

Advantages of the invention may become apparent upon reading the following detailed description and upon reference to the drawings in which:

FIG. 1 is a block diagram of an LCD panel in accordance with an exemplary embodiment of the present invention;

FIG. 2 is a block diagram of a contrast ratio enhancing system in accordance with an exemplary embodiment of the present invention;

FIG. 3A is a block diagram of a backlight linearizer in accordance with an exemplary embodiment of the present invention;

FIG. 3B is a graph illustrating operation of the backlight linearizer in accordance with an exemplary embodiment of the present invention;

FIG. 3C is a graph illustrating operation of the backlight linearizer in accordance with another exemplary embodiment of the present technique.

FIG. 3D is a block diagram of a configuration of the backlight linearizer in accordance with an exemplary embodiment of the present invention;

FIG. 4A is a graph of a nonlinear curve of a backlight illumination in accordance with an exemplary embodiment of the present invention;

FIG. 4B is a graph of a family of curves for linearizing the backlight illumination in accordance with an exemplary embodiment of the present invention;

FIG. 4C is a graph of a linear curve of the backlight illumination in accordance with an exemplary embodiment of the present invention; and

FIG. 5 is flow chart depicting a method for linearizing the backlight illumination in accordance with an exemplary embodiment of the present invention.

### DETAILED DESCRIPTION

One or more specific embodiments of the present invention will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

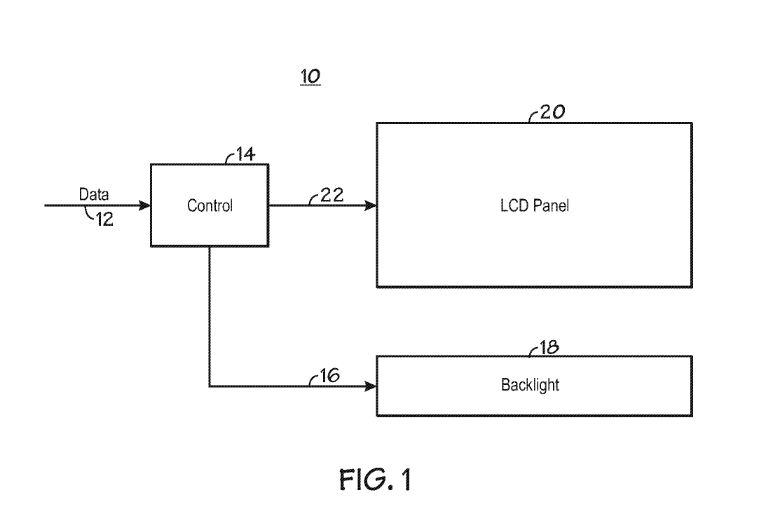

Referring to FIG. 1, a configuration of an exemplary display system 10, such as an LCD panel, in accordance with an exemplary embodiment of the present invention is shown. The figure depicts an LCD panel 20 and an illumination source 18, such as a backlight, controlled by a control system 14. The control system 14, receives data 12, which may include video backlight illumination and liquid crystal pixel data values. The control system 14 may use the data 12 to simultaneously adjust the backlight and the pixel values to enhance the contrast ratio of the LCD panel 20. Accordingly, data 22 outputted by the control system 14 goes into the LCD panel 20 for adjusting the pixel values. Similarly, data 16 outputted by the control system 14 is transmitted into the backlight 18 for adjusting the backlight illumination of the video.

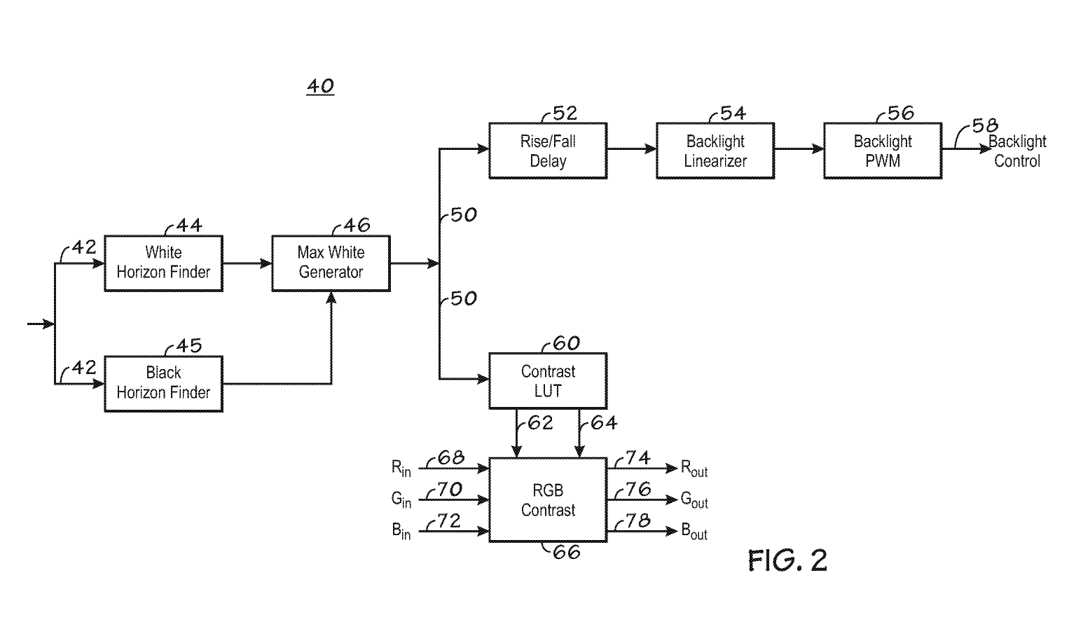

Turning now to FIG. 2, a contrast ratio enhancement control system 40 in accordance with an exemplary embodiment of the present invention is shown. The description set forth of the control system 40 pertains to components controlling the video backlight illumination and the pixel values of the LCD panel 20. Accordingly, a white horizon finder 44 and a black horizon finder 45 receive respective luminance component data 42. The white horizon finder 44 and the black horizon finder 45 respectively determine statistical information relating to the brightness, dark and near-dark levels, and their distribution throughout a video frame. Information obtained by the white horizon finder 44 and the black horizon finder 45 is provided to a maximum white generator 46. The maximum white generator 46 simultaneously controls the backlight illumination and the liquid crystal pixel values. In accordance with embodiments of the present invention, the two are adjusted in a complementary fashion to enhance the contrast ratio of the LCD panel 20.

The maximum white generator 46 adjusts the backlight illumination by determining the brightness of the brightest area of the video frame. This information is then utilized to determine the amount of backlight needed to illuminate the LCD panel 20, for example, as applied by cold-cathode-fluorescent (CCF) lamps. Accordingly, to improve the contrast ratio, a reduced backlight illumination is desired. However, as one of ordinary skill in the art would appreciate, reducing the backlight illumination too much may cause an undesired “white reduction” of the video frame. In order to avoid this, brightness information obtained by the maximum white generator 46 is further utilized to modify the pixel values of the LCD panel to compensate for possible insufficient backlight illumination.

The maximum white generator 46 produces output data 50 for modulating the backlight illumination, while adjusting red, green, and blue (RGB) input values of the LCD panel 20. Hence, to compensate for backlight modulation, the maximum white data 50 is further processed for modifying the pixel values of the LCD panel 20 in a non-linear gamma-corrected domain. Accordingly, the data 50 is delivered to a contrast look-up table (CLUT) 60, which stores adjustment values that are formatted as an RGB offset 62 and an RGB gain-value 64. The RGB offset value 62 and the RGB gain-value 64 are delivered to an RGB contrast circuit 66. Accordingly, input RGB pixel values 68-72 are combined with the RGB offset 62 and the RGB gain-value 64 to output gamma-corrected RGB pixel values 74-78.

In addition to modifying the color pixel values, the data 50 is also delivered to backlight control circuitry, which outputs backlight control data 58. Such backlight control circuitry may include a backlight linearizer 54, as described further below, for compensating nonlinearities in the light characteristic of the backlight. Also included is a rise/fall delay 52, which compensates for time misalignments between the backlight and the raster scanning of the pixels. This may prevent viewer perceived white flashes from appearing on a screen, which are generally undesirable. The backlight control circuitry may further include a backlight pulse width modulator (PWM) 56, which controls the illumination level of the backlight.

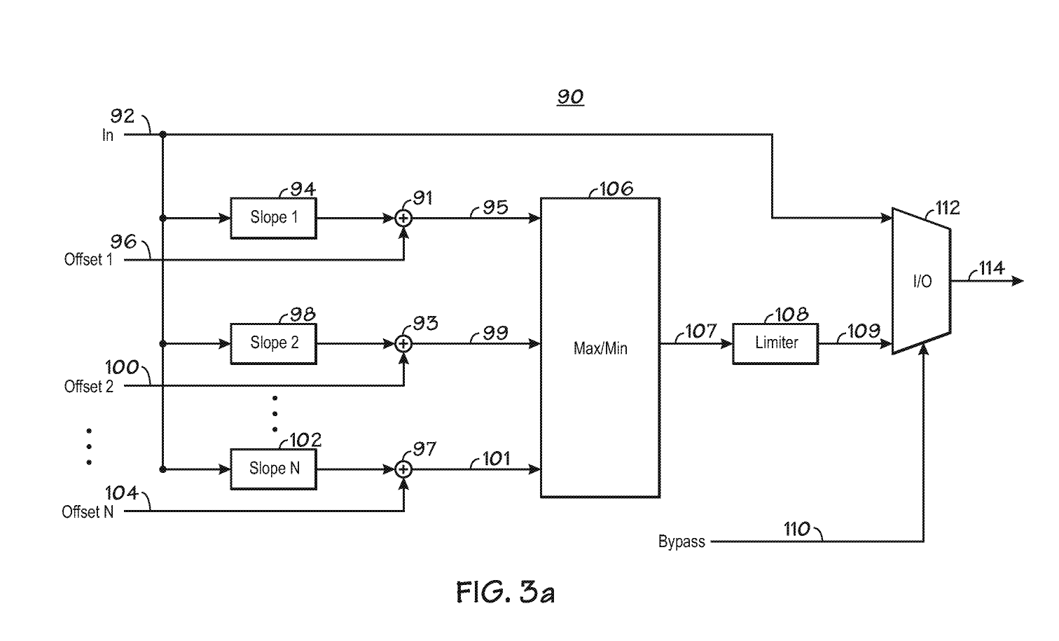

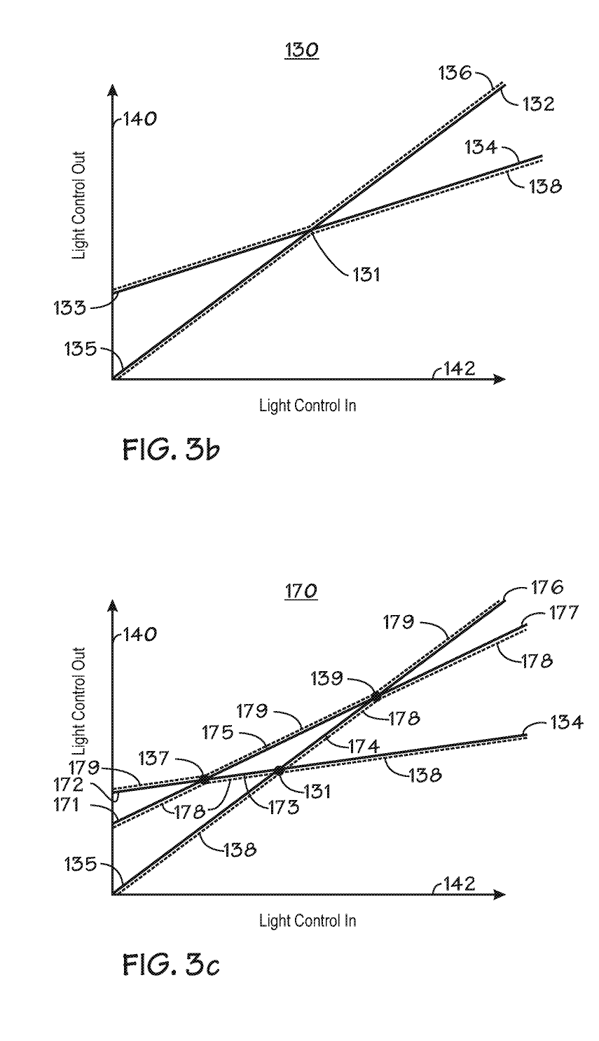

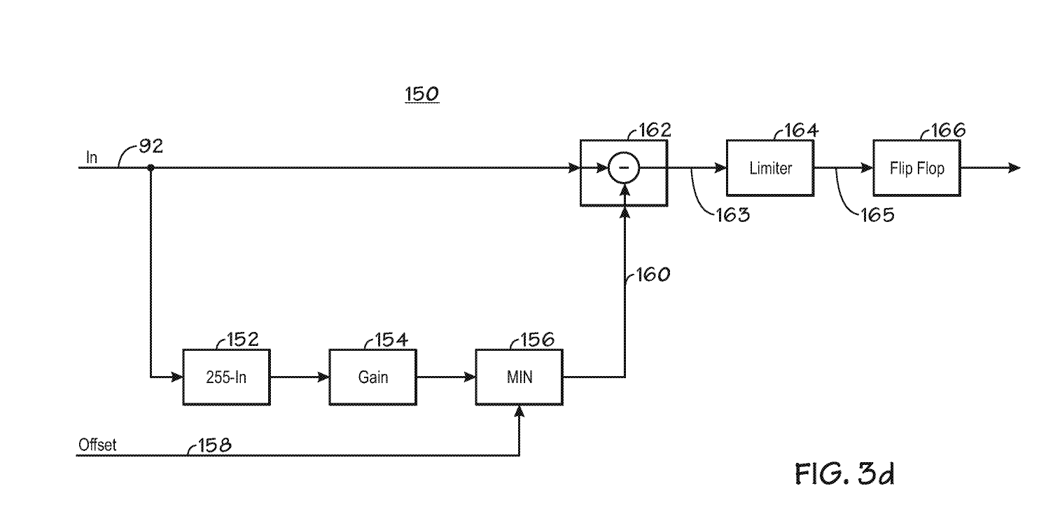

Referring now to FIG. 3A, an exemplary system for the backlight linearizer 54 (FIG. 2) which compensates for non-linearities in the light characteristic of the backlight illumination is depicted. The backlight linearizer 54 may comprise a system generally referred to by the reference numeral 90. The system 90 accepts linear backlight data 92 which is delivered to an I/O interface 112 and slope generating circuits 94, 98 and 102. The slope generating circuits 94, 98, and 102 generate slopes of an ensemble of linear curves that characterize the non-linear light characteristic of the backlight illumination and, thus, facilitate the linearization of the backlight illumination. In constructing such linear curves, the slope generating circuits 94, 98, and 102, are respectively complemented by offsets 96, 100 and 104, which are delivered to adders 91, 93 and 97 for providing appropriate offsets for typifying the non-linear light characteristic of the backlight illumination. In doing so, it should be appreciated that the number of slopes and offsets may vary according to system characteristics and requirements. Accordingly, the slope generating circuits 94, 98, 102 and the offsets 96, 100, 104 are respectively combined to output linear curves data components 95, 99, and 101.

Upon receiving the data of curves 95, 99, and 101, circuit 106 functions to identify points at which the curves 95, 99, and 101 intersect. Accordingly, such intersection points define a collection of piecewise linear transfer characteristic functions utilized to linearize the backlight illumination. Depending on system specifications, block 106 may output a maximum, a minimum, or a combination thereof piecewise transfer characteristic function resulting from the intersections of the data 95, 99, and 101. Thus, the circuit 106 produces data 107, delivered to limiter 108 to ensure the data 107 falls in a prescribed range. Thereafter, resulting data 109 is joined with the data 92 at the input/output (I/O) interface 112 which produces non-linearly compensated backlight data 114 for the backlight control. Also inputted into the I/O interface is a bypass signal 110, which may be used for diagnostic purposes of the backlight.

FIG. 3B is a graph 130 illustrating the principle of operation of the system 90 in accordance with an exemplary embodiment of the present technique. The graph 130 has a horizontal axis 142 denoting light control input, and a vertical axis 140 denoting light control output. In an exemplary embodiment, two linear functions, as implemented by circuit 90, intersect at point 131 to form four line segments. These four line segments are labeled by reference numerals 132-135, and may comprise the ensemble of linear curves produced by the circuit 106 to form piecewise linear transfer characteristic functions of the backlight. In this exemplary embodiment, the circuit 106 may produce a curve corresponding to either a maximum or a minimum piecewise linear transfer characteristic function. Accordingly, a maximum curve may comprise the line segments 132 and 133, while a minimum curve may comprise the line segments 134 and 135. As illustrated by FIG. 3B, dashed curves 136 and 138 respectively depict the general trend of the resulting maximum and minimum piecewise transfer characteristic functions. Further, these curves are distinguished by their positive and negative concavity, respectively. Thus, the curve 136 may have a concavity defining the maximum output, while the curve 138 may have a concavity defining the minimum output, as implemented by circuit 106 for linearizing the backlight.

FIG. 3C is a graph 150 illustrating the principle of operation of the system 90 in accordance with another exemplary embodiment of the present technique. The graph 150 depicts intersections of three linear functions forming nine line segments. The nine line segments comprise an ensemble of curves utilized by circuit 106 to form multiple piecewise linear transfer characteristic functions of the backlight. In this manner, increasing the number of linear functions, as implemented by circuit 90, increases the number of intersection points, which increases the number piecewise linear transfer characteristic functions. This may be advantageous in typifying the backlight of the display device more accurately. Accordingly, the circuit 106 may produce a curve corresponding to a maximum, a minimum, or a combination thereof piecewise linear transfer characteristic function. In this exemplary embodiment, the minimum curve is identical to the minimum curve illustrated by FIG. 3B. The same embodiment provides a maximum curve defined by intersection points 137 and 139, forming line segments 172, 175, and 176. The general trend of the maximum piecewise linear transfer characteristic function formed by these line segments is shown by dashed curve 179.

Circuit 106 may further produce a combination of maximum and minimum line segments to form additional piecewise linear transfer characteristic functions for the backlight. For example, the intersection points 131, 137, and 139 define four line segments 171, 173, 174, and 177. These later line segments form a distinct piecewise linear transfer characteristic function of the backlight. A general trend of a piecewise transfer characteristic curve resulting from the line segments 171, 173, 174, and 177 is depicted by dashed curve 178. The curve 178 is disposed between the maximum curve 179 and the minimum curve 138.

FIG. 3D is another system in accordance with an exemplary embodiment of the present technique of a circuit 150 for linearizing the backlight illumination. The system 150 accepts linear backlight data 92. The linear backlight data 92 is delivered to both a scale circuit 152 and a subtractor 162. The scale circuit 152 subtracts the input data 92 from a value corresponding to a maximum brightness level, such as 255, a value corresponding to a maximum shade of gray. Circuit 154 multiplies the foregoing value by a slope or a gain coefficient, and delivers it to a minimum circuit 156. Configurable offset data 158 inputted into the minimum circuit 156, generates a family of curves for correcting the non-linear characteristic of the backlight. Accordingly, the minimum circuit 156 outputs a minimum value 160 from the data provided by gain block 154 and the offset data 158. Thereafter, the minimum value 160 is subtracted from the linear backlight data 92 by subtractor 162. The subtractor 162 produces data 163. The data 163 is subsequently processed by the limiter 164 to ensure the data 163 falls in a prescribed range of values. The limiter 164 provides data 165 to circuit 166, or more commonly known to those skilled in the art as a flip-flop. Lastly, circuit 166 produces linear backlight data for the backlight control 58 (FIG. 2).

The processing of linear backlight data 92 by the system 150 to output non-linear backlight data can be mathematically described by an equation of the form:

OUTPUT=INPUT−MINIMUM(OFFSET,SLOPE(255−INPUT))

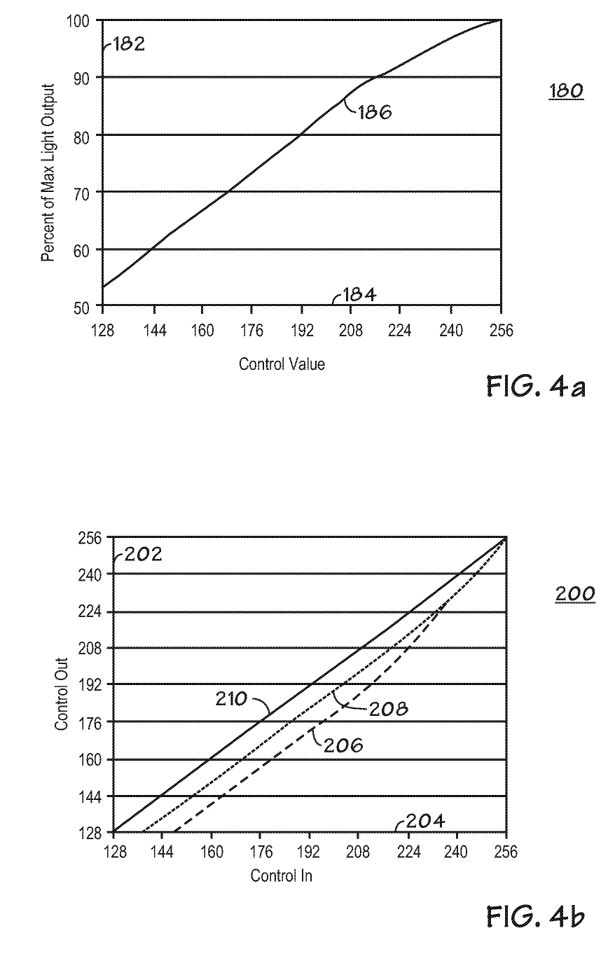

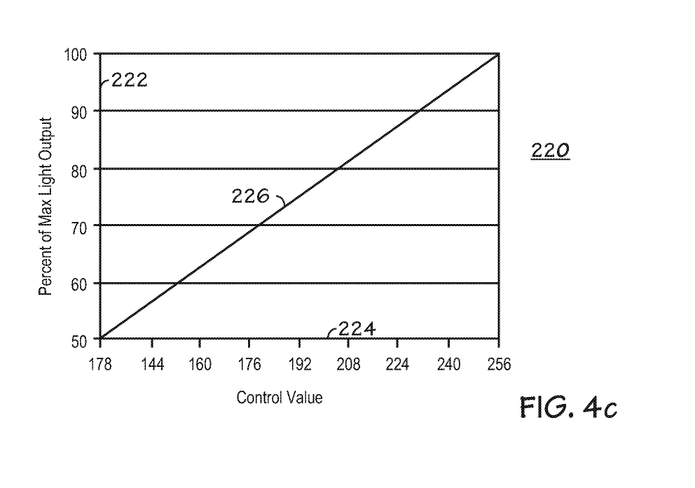

Referring now to FIG. 4A, an exemplary graph 180 in accordance with an exemplary embodiment of the present invention is illustrated. The graph 180 characterizes a non-linear backlight output verses PWM control values of the backlight apparatus. Accordingly, a vertical axis 182 denotes percent of maximum white output, and a horizontal axis 184 denotes control values of the backlight illumination. Such an exemplary curve may comprise a maximum control value of 256 corresponding to a 100 percent light-output. As illustrated by the curve 186, a non-linear component in the backlight illumination exists, particularly in the upper portion of the curve 186 corresponding to high brightness levels.

Referring to FIG. 4B, an exemplary graph 200 in accordance with embodiments of the present technique is depicted. The graph 200 illustrates a collection of curves 206-210 used by the backlight linearizer 54 to compensate for the nonlinear characteristic of the backlight. Accordingly, a vertical axis 202 and a horizontal axis 204 respectively denote control out and control in values of the backlight. Each of the curves 206-210 may correspond to different offset values. For example, curve 208 may provide a suitable offset curve for compensating a nonlinear characteristic of the backlight illumination, illustrated by curve 186.

FIG. 4C illustrates a graph 220 in accordance with embodiments of the present invention. The graph 220 depicts a curve resulting from employing the exemplary curve 208 of FIG. 4B. The curve 208 is best chosen out of the family of curves 200 of FIG. 4B, for linearizing the nonlinear characteristic of the backlight, illustrated by the exemplary curve 186 of FIG. 4A. Depending on the non-linear characteristic inherent in the backlight, different curves provided by the family of curves 200 may be used to produce a range of respective offset and slope parameters 96, 100, 104, and 94, 98, 102 (FIG. 3A-C) for linearizing the backlight illumination.

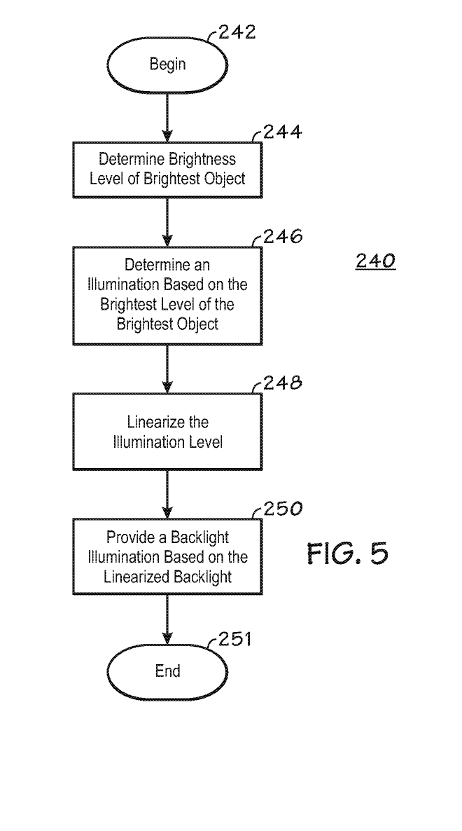

Referring to FIG. 5, a method for linearizing the backlight illumination is illustrated by a flow chart, generally referred to by reference numeral 240. The method begins at block 242 where the data 42 is delivered into the white horizon finder 44. At block 244, the pixel brightness level of the brightest object is determined by the white horizontal finder 44. Based on the brightness level of the brightest object, a desired backlight illumination is determined by the maximum white generator 46 as denoted by block 246. Thereafter, at block 248 the backlight illumination is linearized, and at block 250 the linearized backlight illumination is provided for the display device. Lastly, the method ends at block 251.

While the invention may be susceptible to various modifications and alternative forms, specific embodiments have been shown by way of example in the drawings and will be described in detail herein. However, it should be understood that the invention is not intended to be limited to the particular forms disclosed. Rather, the invention is to cover all modifications, equivalents and alternatives falling within the spirit and scope of the invention as defined by the following appended claims.

What is claimed is:

1. A video unit, comprising:
an illumination source; and
a circuit coupled to the illumination source, the circuit adapted to linearize the illumination source using characteristic parameters of the illumination source.

2. The video unit recited in claim 1, wherein the characteristic parameters of the illumination source form at least two linear curves.

3. The video unit recited in claim 2, wherein the at least two linear curves are processed by the circuit simultaneously.

4. The video unit recited in claim 2, wherein the circuit is adapted to use intersection points of the at least two linear curves to obtain piecewise linear transfer characteristic functions for linearizing the illumination source.

5. The video unit recited in claim 1, wherein the circuit is adapted to obtain a maximum a minimum or a combination thereof piecewise linear transfer characteristic function for linearizing the illumination source.

6. The video unit recited in claim 1, wherein the circuit is adapted to linearize the illumination source while an adjustment is made to color pixel values in a gamma corrected domain.

7. A method of linearizing an illumination source of a display device, the method comprising:
determining a brightness level of a brightest object of a video frame;
determining an illumination level for the video frame based on the brightness level of the brightest object;
linearizing the illumination level; and
providing an illumination of the display device based on the linearized illumination level.

8. The method recited in claim 7, comprising using statistical information to determine a pixel brightness level of the brightest object of the video frame.

9. The method recited in claim 7, wherein the illumination level is linearized using at least one piecewise linear transfer characteristic function.

10. The method recited in claim 9, wherein the at least one piecewise linear transfer characteristic function comprises an intersection of at least two linear curves associated with a light characteristic of the illumination level.

11. The method recited in claim 10, wherein each of the at least two linear curves comprise slopes and offsets associated with characteristic parameters of the illumination source.

12. The method recited in claim 7, comprising obtaining a maximum a minimum or a combination thereof piecewise linear transfer characteristic function for linearizing the illumination source.

13. The method recited in claim 7, comprising adjusting color pixel values in a gamma corrected domain based on the illumination level of the video frame.

14. The method recited in claim 7, comprising linearizing the illumination level while adjusting color pixel values.

15. A system for linearizing an illumination source of a display device comprising:
means for determining a brightness level of a brightest object of a video frame;
means for determining an illumination level for the video frame based on the brightness level of the brightest object;
means for linearizing the illumination level; and
means for providing an illumination of the display device based on the linearized illumination level.

16. The system recited in claim 15, wherein the means for linearizing the illumination source employs at least one piecewise linear transfer characteristic function.

17. The system recited in claim 16, comprising means for obtaining the piecewise linear transfer characteristic function by intersecting at least two linear curves associated with the light characteristic of the illumination source.

18. The system recited in claim 17, comprising means for providing slopes and offsets for the at least two linear curves associated with the light characteristic of the illumination source.

19. The system recited in claim 15, comprising means for obtaining a maximum a minimum or a combination thereof piecewise linear transfer characteristic function for linearizing the illumination source.

20. The system recited in by claim 15, comprising means for modifying pixel values in a gamma corrected domain while linearizing the illumination source.
